(19) United States
(12) Patent Application Publication
(10) Pub. No.: US 2002/0075291 A1
(43) Pub. Date: Jun. 20, 2002

(54) Method of organizing and presenting message and deadline information in an electronic calendar system

(76) Inventors: Henricus Antonius Wilhelmus Van Gestel, Eindhoven (NL); Nathalie Dorothee Pieternel Leurs, Eindhoven (NL)

Correspondence Address: U.S. Philips Corporation, 580 White Plains Road, Tarrytown, NY, 10591, US

(21) Appl. No.: 09/969,714

(22) Filed: Oct. 3, 2001

(30) Foreign Application Priority Data
Oct. 8, 2000 (EP) 00203489.0

(51) Int. Cl. G06F 3/14

(52) U.S. Cl. 345/700; 345/963

(57) ABSTRACT

Message and deadline information in an electronic calendar system is organized by calculation of the time difference between the deadline and the time of entry to obtain for each entered message a remaining time information, which is adjusted with the progress of time towards the deadline.

To provide an organized display presentation schedule, in which priority is given to displayed messages and/or deadlines in dependence on the remaining time the remaining time information is visualized by changing at least one display format attribute of the message and/or deadline information in dependence on the adjustment of the remaining time.

The present invention relates to a method of organizing and displaying message and deadline information in an electronic calendar system, comprising the steps of entry and storage of said message and deadline information in an electronic data processing device having stored information of the time of entry, calculating the time difference between the deadline and the time of entry to obtain for the entered message information of remaining time until deadline, and adjusting said remaining time information in accordance with the progress of time from the time of entry towards the deadline.

Electronic calendar systems whether implemented as a stand alone calendar for private or office use, as application software for a personal computer or as part of a bulletin board contain messages and reminders of events to which the individual using the calendar system is required or expected to attend or of which the individual should at least take note.

Typically such reminders and some messages contain a deadline, i.e. the point in time, at which an event will take place or for which a job or project, for which the individual is responsible, must be completed. After the deadline has been passed, any reminder about the deadline would generally be of no use anymore.

In some conventional calendar systems reminders containing deadlines are typically presented to the user at a fixed point in time prior to the scheduled event, e.g. 15 minutes before a meeting appointment or one day prior to an event. In other systems messages containing deadlines are entered into a “things to do” list on the current day and are then moved day by day, until they have been indicated as done.

In international patent application WO 93/05451 a programmable clock including a combination of analog and digital display means as well as audio and/or video alarms is disclosed, in which reminders about deadlines are presented by illumination of discrete LED's, which for hour-minute presentation may be arranged in conjunction with a conventional circular arrangement of hour-minute indications, and date related presentation may be arranged in a limited number to indicate the occurrence of deadlines for a corresponding number of days after the current date. Factual information about the message related to the deadline is only presented for the deadline closest to the current point in time in the form of an alpha-numeric message on a display.

In U.S. Pat. No. 4,005,571 a prior art electronic reminder device is disclosed, in which entries are made of the current time and the deadline of a future appointment or event and the elapsed time interval between the current date and the deadline is automatically calculated and updated as time progresses. Also in this case only the time of the deadline, but not the associated message is presented. For additional warning or signaling the user that the deadline has arrived the visual display may operate in a flashing mode and/or be combined with an audible signaling device such as a horn or a buzzer. Evidently, in this prior art device the absence of any information about the appointment or event limits the value of the elapsed time calculation.

Thus, whereas in the solutions known in the art reminders are typically not made visible, until the deadline is really close and many solutions suffer from the additional disadvantage that only the deadline itself is presented to the user without any information about the appointment or event, to which it relates, it is an object of the invention to allocate priority to message and deadline entries in an electronic calendar system and to provide an organizing and display method including visualization of the remaining time until the deadline in connection with presentation of deadline and message entries in an organized schedule.

According to the invention these objects and other advantages to be further described are achieved by a method as defined, which is characterized in that as part of an organized deadline and message schedule each entered message and deadline information is displayed on display means controlled by said data processing device in a predetermined display format, in which the remaining time information is visualized by changing at least one display format attribute of the message and/or deadline information in dependence on the adjustment of the remaining time information to provide a display presentation of said organized schedule, in which priority is given to displayed messages and/or deadlines in dependence on the remaining time.

For message and deadline information displayed in alpha-numeric format, the display format attribute, which in accordance with the invention is changed in dependence on the remaining time until the deadline, may comprise any or a combination of a variety of attributes, which may include e.g. the size or color of the message presentation or its position within the presentation area of the display means, such as a conventional computer screen.

By means of the method of the invention the user's attention to the displayed message presentations will be automatically concentrated on the most important and urgent deadlines.

Preferred and advantageous ways of implementation of the method are stated in dependent claims 2 to 8.

In particular, the method of the invention is well-suited for use in a bulletin board system, in which further messages without any associated deadline are entered and visualized priority may be allocated to individual ones of such messages.

The invention further relates to a computer program product comprising stored data and software instructions for carrying out the method as defined by means of a data processing device.

Examples of implementation of the method according to the invention will be further explained in the following with reference to the drawings, in which

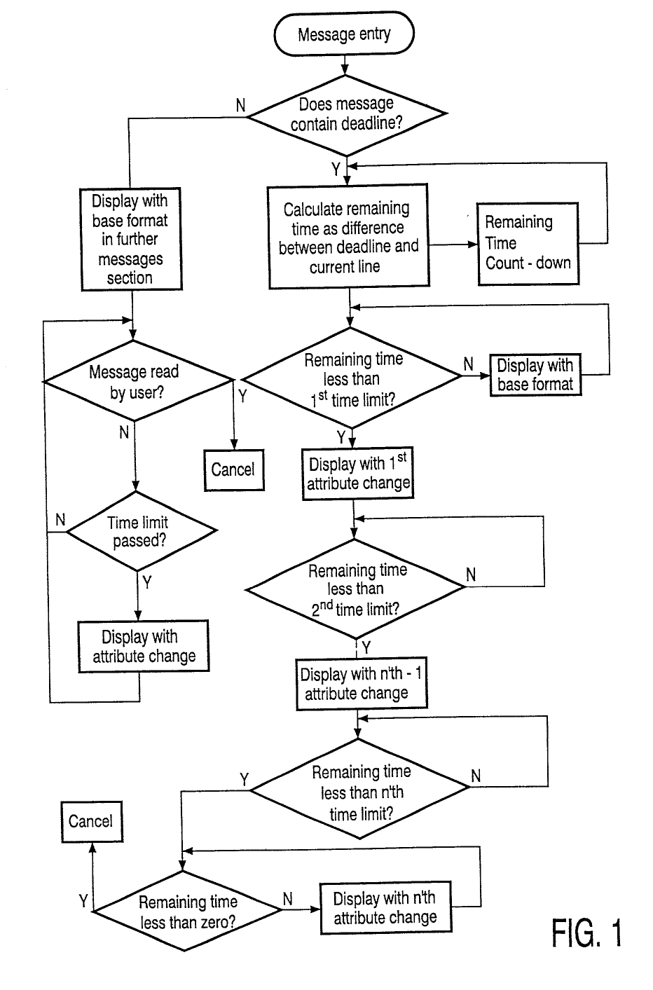

FIG. 1 is a flow diagram illustrating an example of implementation of the method according to the invention, and

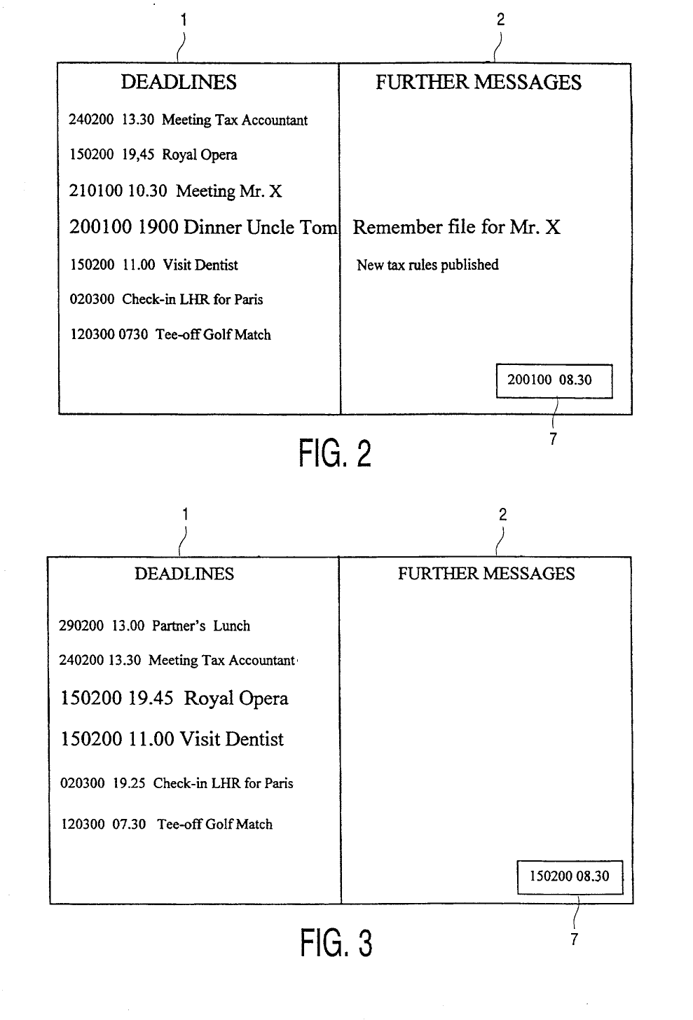

FIGS. 2 to 6 are simplified graphic representations of screen pictures illustrating different examples of implementation.

In the example illustrated by the flow diagram in FIG. 1 it is assumed that an electronic calendar system, to which the method according to the invention is applied, forms part of a bulletin board, in which both messages containing deadlines and messages without deadlines are entered and may be displayed to the user.

Thus, upon entry of a message at a specified point in time it is determined, whether the message contains a deadline. If this determination is affirmative, the remaining time to the deadline for the entered message is calculated from the time of entry as a simple subtraction, obviously taking into account, however the varying number of days in different months of the year including the occurrence of an intercalendary day in leap years.

If no deadline is contained, the message is routed to the work station or stations of the actual addressee or addressees to be displayed in a further messages section on the display screen of each such work station.

For each message containing a deadline the remaining time calculation is repeated regularly as time progresses, e.g. every minute or with any other suitable interval, which may be user adjustable. Further, checks are carried out with regular intervals, e.g. every hour, to determine whether each entered deadline has become shorter than any of a number of predetermined time limits, as a consequence of which the message and/or deadline information associated with it should be displayed with change of at least one display format attribute.

Thus, in the example shown in FIG. 1, it is determined whether the remaining time has become shorter than a 1^{st} time limit, which could e.g. be 30 days. If this is not the case, the message and/or deadline information will be displayed with a base format.

If the 1^{st} time limit has been passed, the message and/or deadline information will be displayed with change of one display format attribute, as will appear from the examples described in the following and illustrated in FIGS. 2 to 6, and a new determination is made, whether a 2^{nd} time limit has been passed. If not, no further change is made with respect to the display format.

When the 2^{nd} time limit, which could e.g. be 15 days, is passed, display will take place with a second change of a display format attribute, which could either be a further change to the attribute already changed, when passing the 1^{st} time limit or a change of a different display format attribute.

When as time progresses the deadline for a message comes closer the remaining time will pass an n'th-1 time limit, which could e.g. be 48 hours, and the message and/or deadline information is now displayed with an n'th-1 attribute change.

When subsequently the ultimate n'th time limit, which could e.g. be 24 hours, is passed the display will be made with an n'th attribute change, which in the illustrated example will be maintained, until the remaining time reaches zero meaning that the deadline has finally come up, and as a consequence of which the message and deadline information will be cancelled.

For messages entered without deadlines, which in the illustrated example will be displayed in a further messages section of the display of the work station of any appointed addressee of the message. Following initial display of the message in a base format, a determination may be made at regular intervals, e.g. every hour, as to whether the message has actually been read by the user, which is determined by inputting of an electronic confirmation by the user. When the message has been read by an individual user, to whom it was addressed, it may be cancelled from the work station of the user. If the message has not been read within a specified time limit calculated from the time of entry of the message, at least one display format attribute of the message is changed. The specified time limit could be any of a number of fixed time limits allocated to the bulletin board system or be individually adjustable on a message by message basis.

FIGS. 2 to 6 show simplified graphic representations of the display of examples of message entries, with and without deadlines, in accordance with the method of the invention, each figure showing the appearance of the screen display at a specified point in time and with the display presentation area of the screen used for the purposes of the method divided in to two sections 1 and 2 for the display of messages with and with deadline information, respectively. At the bottom of the further messages section 2 the current clock time is shown in a field 7.

The example in FIG. 2 shows the display as appearing on Thursday Jan. 20, 2000 at the clock time 08.30 in the morning of a sequence of previously entered messages 10 with and without deadlines. The messages with deadlines including in chronological deadline order the following events:

| Deadline | Message |
|---|---|
| 200100 19.00 | Dinner Uncle Tom |
| 210100 10.30 | Meeting Mr. X |
| 150200 11.00 | Visit Dentist |
| 150200 19.45 | Royal Opera |
| 240200 13.30 | Meeting Tax Accountant |
| 020300 19.25 | Check in LHR for Paris |
| 120300 07.30 | Tee-off Golf Match |

In this example only two time limits, namely 48 hours and 24 hours have been used.

As will appear all messages having deadlines more than 48 hours from the clock time are displayed with a base format, indicated in the illustrated typographical reproduction by normal 10 pitch typing. When the first time limit of 48 hours before the deadline is passed for a message, in this example the message having the deadline 210100 10.30, the message is displayed, on one hand with 12 pitch typing, and is moved, on the other hand to a focal position close to the middle of the deadline section of the display area. Thus, by passing the limit two display format attributes have been changed, namely the size of the characters of the message and its position in the display area.

When the also the next time limit, which in the illustrated example is 24 hours before the deadline is passed, a further attribute change results, namely in this example a further change of the character size to 14 pitch.

In the further messages section of the display area two messages have been entered. One of these messages read

“Remember file for Mr, X”,

and is related to the deadline entry for 210100 10.30.

As will appear this message, which has not been marked by the user as read, is displayed with the same attribute changes as the most urgent deadline entry, i.e. 14 pitch typing and display in a focal position in the middle of the further messages section of the display area.

The other message reading

“New tax rules published”,

which has been entered into the further messages section 2, is an information message of general interest to a number of users of the bulletin board and has therefore been addressed to all such users, who may individually input confirmation of having read the message to delete it from their display screens.

FIG. 3 shows the same display screen and use of the same display format and attribute changes as in FIG. 2 at the clock time 150200 0830. While the entries for 200100 and 210100 have disappeared, the two entries for 150200, for which the 24 hours time limit has been passed, are now displayed with the maximum character size and moved to the focal position in the middle of the deadline section 1. Moreover, an additional entry for 290200 has been entered and placed at the top of the deadline section away from the focal position.

In the further messages section both of the messages shown in FIG. 2 have now been deleted as having been read by the user.

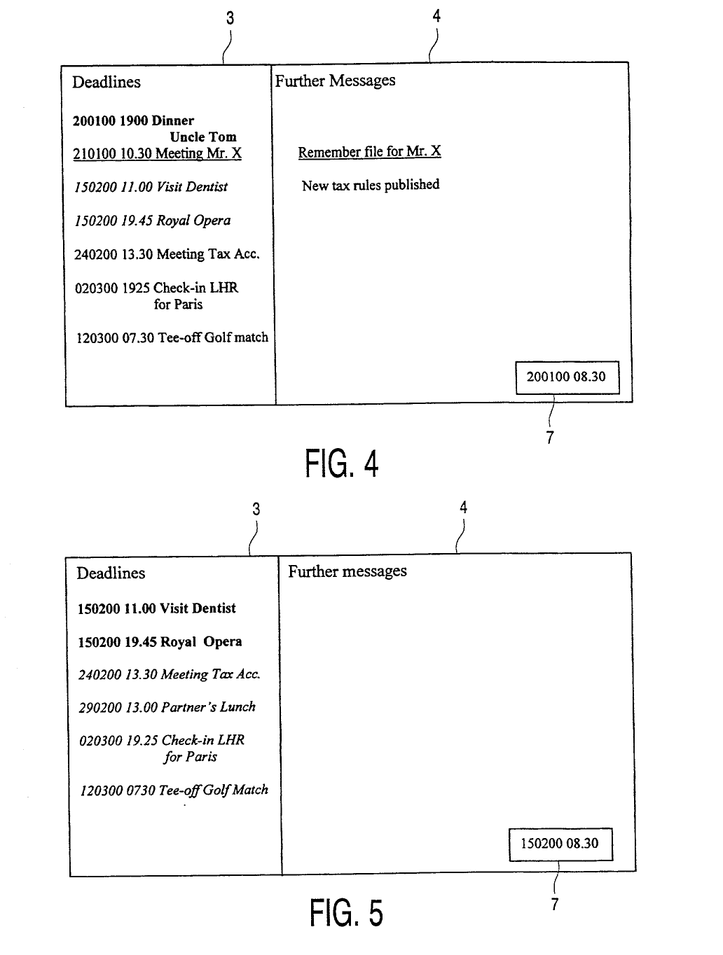

The example illustrated in FIGS. 4 and 5 show the same entries of deadlines and further messages as appearing at the same clock times as in FIGS. 2 and 3, respectively, but with a differently organized schedule, in which all deadlines are displayed in chronological order from the top towards the bottom of the deadline section 3.

Moreover, in this example three time limits are used, namely 30 days, 48 hours and 24 hours prior to the actual deadline, respectively.

In FIG. 4 the first time limit of 30 days has been passed by the two entries for 150200, the second time limit of 48 hours by the entry for 210100 and the third time limit of 24 hours by the entry for 200100.

In this example all deadlines and messages are displayed with the same character size, i.e. 10 pitch, and only one attribute change for each time limit, which is passed. Thus, whereas for entries still having a remaining time until deadline of more than 30 days normal typing is used as a base format, the two entries having passed the 30 days time limit, but being still outside the 48 hours time limit are reproduced in italics, whereas the entry for 210100 having passed the 48 hours time limit, but being still outside the 24 hours time limit is reproduced with underlining and the entry for 200100 having passe the last 24 hours time limit is reproduced with bold characters.

As shown in FIG. 5 the two entries for 150200 have both passed the 24 hours time limit and are displayed with bold characters, whereas the remaining deadlines, all of which have come within the 30 days time limit are displayed in italics.

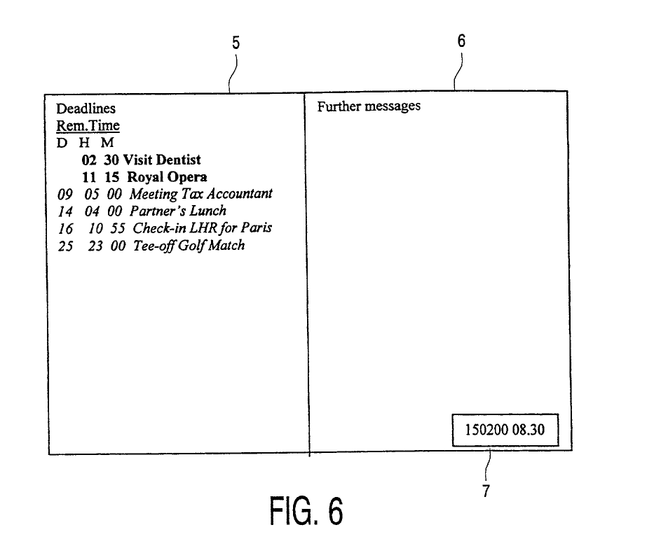

In FIG. 6 a modified version of the schedule organization shown in FIG. 5 is illustrated, in which the information on actual deadlines has been changed from the date and clock time format used in FIG. 5 to an indication of the remaining time until the deadline measured in days D, hours H and minutes M.

Whereas for obvious reasons of black and white reproduction the attribute changes illustrated in FIGS. 2 to 6, in addition to variation in display position in the deadline section of the display area, have been limited to changes in the size and the setting of characters in the deadline and message information, it will understood, that a multitude of alternative forms of attribute changes will possible. Thus, with use of color display an obvious alternative attribute change would be a change of color of display, i.e., such that messages still outside the time limits longest away from the deadline are displayed e.g. in blue, whereas the color changes with progress of time, e.g. to green for the first time limit, yellow for the second time limit and red for the last time limit A further obvious attribute change could be the use of a flashing display for the most urgent entries.

In accordance with the invention all data and software instructions for the conduct of the method according to the invention including the actions of entry of deadlines and message, calculation of remaining time until deadline, comparison of the remaining time with a number of prescribed time limits and control of the display schedule organization and attribute changes may be stored in a computer program product, which could typically be a number of computer diskettes or a CD-ROM, but may also be a program facility in a server installation with website accessible via the Internet.

1. A method of organizing and displaying message (2) and deadline (1) information in an electronic calendar system, comprising the steps of entry and storage of said message and deadline information in an electronic data processing device having stored information of the time of entry, calculating the time difference between the deadline and the time of entry to obtain for the entered message information of remaining time until deadline, and adjusting said remaining time information in accordance with the progress of time from the time of entry towards the deadline and displaying, characterized in that as part of an organized deadline and message schedule each entered message and deadline information is displayed on display means controlled by said data processing device in a predetermined display format, in which the remaining time information is visualized by changing at least one display format attribute of the message and/or deadline information in dependence on the adjustment of the remaining time information to provide a display presentation of said organized schedule, in which priority is given to displayed messages and/or deadlines in dependence on the remaining time.

2. A method as claimed in claim 1, characterized in that in the display presentation of said organized schedule individual message and deadline entries are organized in consecutive position on a remaining time scale starting with the entry having the shortest remaining time.

3. A method as claimed in claim 1 or 2, characterized in that in the display presentation of said organized schedule at least the message and deadline entry having the shortest remaining time is displayed with a size bigger than the size of at least one entry having a longer remaining time.

4. A method as claimed in any of claims 1 to 3, characterized in that in the display presentation of said organized schedule at least the message and deadline entry having the shortest remaining time is displayed with a color different from the color of the presentation of at least one entry having a longer remaining time.

5. A method as claimed in any of the preceding claims, characterized in that in the display presentation of said organized schedule at least the message and deadline entry having the shortest remaining time is displayed at a predetermined focal position on said display means.

6. A method as claimed in any of the preceding claims, characterized by its use in a bulletin board system, in which further messages without any associated deadline are entered and visualized priority may be allocated to individual ones of such messages.

7. A method as claimed in claim 6, characterized in that said bulletin board is incorporated in a network arrangement of workstations for individual users, in which entries of message and deadline information as well as said further messages for any individual user may be performed from any workstation in the network and the display presentation of organized schedules is performed on a user allocated basis.

8. A method as claimed in claim 6 or 7, characterized in that said message and deadline information and said further message information are displayed in distinct separate sections (1,2) on said display means.

9. A computer program product comprising stored data and software instructions for carrying out the method claimed in any of the foregoing claims by means of a data processing device.

10. A data processing device for carrying out the method claimed in any of claims 1 to 8.
